(19) United States
(12) Patent Application Publication
(10) Pub. No.: US 2026/0260396 A1
(43) Pub. Date: Sep. 3, 2026

(54) METHOD AND DEVICE FOR GENERATING VIDEO CLIP BASED ON TEXT DESCRIPTION AND SEQUENCE OF KEY POINTS SYNTHESIZED BY DIFFUSION MODEL

(71) Applicant: SAMSUNG ELECTRONICS CO., LTD., Suwon-si (KR)

(72) Inventors: Kirill Vladislavovich DEMOCHKIN, Nizhny Novgorod (RU); Konstantin Victorovich SOBOLEV, Kirov (RU); Arsen Rinatovich KUZHAMURATOV, Moscow (RU); Mikhail Denisovich ZHIRNOV, Moscow (RU); Mikhail Evgenievich BORTNIKOV, Ekaterinburg (RU); Alexey Stanislavovich CHERNYAVSKIY, Moscow (RU)

(73) Assignee: SAMSUNG ELECTRONICS CO., LTD., Suwon-si (KR)

(21) Appl. No.: 19/659,362

(22) Filed: Apr. 27, 2026

Related U.S. Application Data
(63) Continuation of application No. PCT/KR2024/010618, filed on Jul. 23, 2024.

(30) Foreign Application Priority Data
Jan. 18, 2024 (RU) 2024101227

(51) Int. Cl. G06T 11/00; G06T 7/70

(52) U.S. Cl. CPC G06T 11/00; G06T 7/70; G06T 2207/20084

(57) ABSTRACT

A method of generating a video clip from a text description is provided. The method may include receiving the text description of the video clip to be generated. The method may include obtaining, based on the received text description, a vector representation of the text description. The method may include obtaining a vector representation of a sequence of key points of the video clip to be generated, by a diffusion motion model based on the obtained vector representation of the text description. The method may include mapping the vector representation of the sequence of key points to a series of key point images of the video clip being generated, wherein each key point image from the series corresponding to a respective frame of the video clip being generated. The method may include generating a frame sequence of the video clip.

### CROSS-REFERENCE TO RELATED APPLICATIONS

This application is a Continuation application of International Application PCT/KR2024/010618 filed on Jul. 23, 2024, which claims priority to Russian Patent Application No. 2024101227, filed on Jan. 18, 2024, the disclosures of which are incorporated herein in their entireties by reference.

### FIELD

The embodiment of the disclosure relates to the field of machine learning-based models that implement the synthesis of video clips based on text descriptions (prompts) and additional conditioning synthetic information that defines dynamics of object(s) in the video clip frames being generated, which correspond to the concepts conveyed by the text description.

### BACKGROUND

There are generative models for converting a text description into a video clip. As an input, such models receive a text description, and as an output, such models usually generate a video clip in which objects and their placements to a certain degree correspond to the concepts that are described by the text description. However, the quality of the video clips generated by such models and the conceptual correspondence of these video clips to the transmitted text description leave much to be desired.

To improve the quality of the generated video clips and their correspondence to the transmitted text descriptions, models have been proposed for converting text descriptions into video clips, which, in addition to the text descriptions, are conditioned by a sequence of reference video images. However, the disadvantage of such models is the need to find reference video clips corresponding to text descriptions. The number of video clips in the public domain that could be considered to correspond to certain text descriptions and, accordingly, used as appropriate references, is very limited and insufficient to cover the full variety of possible concepts conveyed by various possible formulations of text descriptions. Thus, it would be useful to provide a model for converting a text description into a video clip that would generate a video clip of similar quality, but without using the actual reference video clips or any information extracted from them at the inference stage.

### SUMMARY

According to an embodiment of the disclosure, a method of generating a video clip from a text description is provided. According to an embodiment of the disclosure, the method may include receiving the text description of the video clip to be generated. According to an embodiment of the disclosure, the method may include obtaining, based on the received text description, a vector representation of the text description. According to an embodiment of the disclosure, the method may include obtaining a vector representation of a sequence of key points of the video clip to be generated, by a diffusion motion model based on the obtained vector representation of the text description. According to an embodiment of the disclosure, the method may include mapping the vector representation of the sequence of key points to a series of key point images of the video clip being generated, wherein each key point image from the series corresponding to a respective frame of the video clip being generated. According to an embodiment of the disclosure, the method may include generating a frame sequence of the video clip.

According to an embodiment of the disclosure, an electronic device configured to generate a video clip from a text description, including one or more processors and memory storing instructions that, when executed by the one or more processors individually or collectively, cause the electronic device to receive the text description of the video clip to be generated. According to an embodiment of the disclosure, the instructions that, when executed by the one or more processors individually or collectively, may cause the electronic device to obtain, based on the received text description, a vector representation of the text description. According to an embodiment of the disclosure, the instructions that, when executed by the one or more processors individually or collectively, may cause the electronic device to obtain a vector representation of a sequence of key points of the video clip to be generated, by a diffusion motion model based on the obtained vector representation of the text description. According to an embodiment of the disclosure, the instructions that, when executed by the one or more processors individually or collectively, may cause the electronic device to map the vector representation of the sequence of key points to a series of key point images of the video clip being generated, wherein each key point image from the series corresponding to a respective frame of the video clip being generated. According to an embodiment of the disclosure, the instructions that, when executed by the one or more processors individually or collectively, may cause the electronic device to generate a frame sequence of the video clip.

According to an embodiment of the disclosure, a non-transitory computer-readable storage medium storing computer-executable instructions is provided. According to an embodiment of the disclosure, the computer-executable instructions that, when executed by the at least one processor, may cause the at least one processor to receive the text description of the video clip to be generated. According to an embodiment of the disclosure, the computer-executable instructions that, when executed by the at least one processor, may cause the at least one processor to obtain, based on the received text description, a vector representation of the text description. According to an embodiment of the disclosure, the computer-executable instructions that, when executed by the at least one processor, may cause the at least one processor to obtain a vector representation of a sequence of key points of the video clip to be generated, by a diffusion motion model based on the obtained vector representation of the text description. According to an embodiment of the disclosure, the computer-executable instructions that, when executed by the at least one processor, may cause the at least one processor to map the vector representation of the sequence of key points to a series of key point images of the video clip being generated, wherein each key point image from the series corresponding to a respective frame of the video clip being generated. According to an embodiment of the disclosure, the computer-executable instructions that, when executed by the at least one processor, may cause the at least one processor to generate a frame sequence of the video clip.

### BRIEF DESCRIPTION OF DRAWINGS

These and other aspects of the embodiment of the disclosure will be described in detail below with reference to the accompanying drawings, in which:

FIG. 1 illustrates a schematic representation of the sequence of operations for generating a video clip from a text description and the main components of a method for generating the video clip from the text description by which the above operations are performed.

FIG. 2 illustrates the diffusion process of the diffusion motion model according to an embodiment of the disclosure.

FIG. 3 illustrates the sequence of operations performed during the reverse process in training the diffusion motion model according to an embodiment of the disclosure.

FIG. 4 illustrates the non-limiting implementation of the sequence of operations of generating training data used in training the diffusion motion model according to an embodiment of the disclosure.

FIG. 5 illustrates the non-limiting implementation of the sequence of operations of mapping the vector representation of sequence of video clip key points to a series of images of video clip key points.

FIG. 6 illustrates the non-limiting example of the series of two-dimensional images 601-616 of video clip key points, obtained by the mapping operation schematically represented in FIG. 5.

FIG. 7 illustrates the non-limiting example of the series of two-dimensional images 701-715 of video clip key points, wherein each two-dimensional image of the video clip key points (bottom portion of each picture) is presented in this figure in pair with the corresponding video clip frame (top portion of each picture) generated by the stable diffusion model under the control of the controlling neural network model.

FIG. 8 illustrates the non-limiting example of the series of two-dimensional images 801-807 of video clip key points, wherein each two-dimensional image of the video clip key points (bottom portion of each picture) is presented in this figure in pair with the corresponding video clip frame (top portion of each picture) generated by the stable diffusion model under the control of the controlling neural network model.

FIG. 9 illustrates a schematic diagram of an electronic device according to an embodiment of the disclosure, which is configured to implement the method of the first aspect of the embodiment of the disclosure or according to any development of the first aspect of the embodiment of the disclosure.

### DETAILED DESCRIPTION

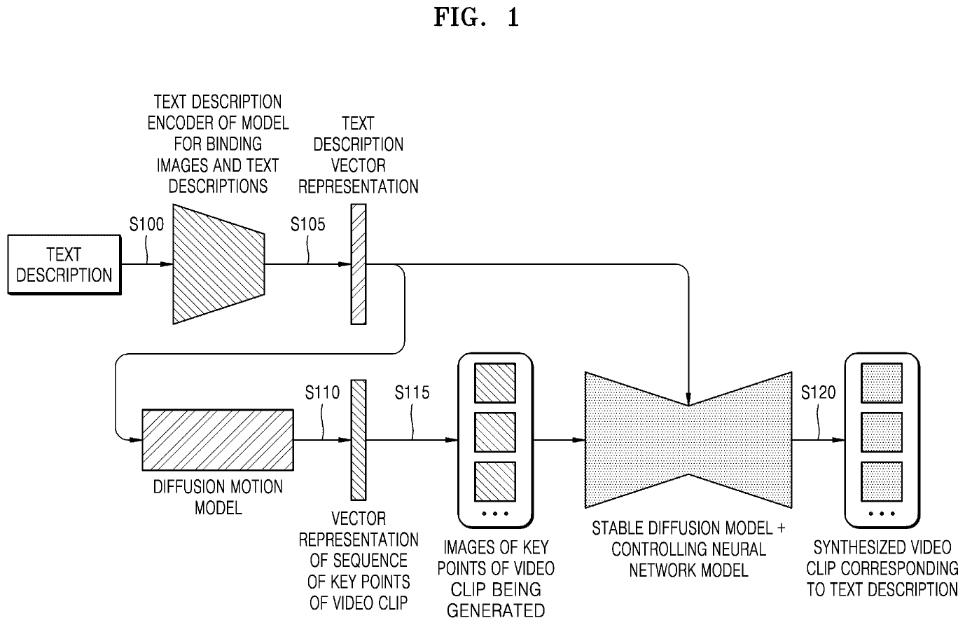

First, the general sequence of operations of the method and the corresponding system components that implement these operations are described in detail with reference to FIG. 1. The method begins with step S100 of obtaining (e.g., receiving) a text description of the video clip to be generated. A length of the text description, contents of the text description, or a language of the text description are not anyhow limited, provided that the neural network model for binding images and text descriptions used at the following step S105 has been previously trained to support such length, contents, and language of the input text description. Non-limiting examples of text descriptions may include “the girl laughs loudly”, “bear is dancing”, etc. A text description is text that describes in words the video clip (e.g. its contents, character, dynamics, scene, etc.) that is to be generated. Instead of the term “text description”, equivalent terms can be used, for example, “text prompt”, “prompt”, “hint” and the like. It can be the that the text description in the technical solutions disclosed herein serves as a starting point or, to put it another way, as a condition for generating a video clip. The term “vector representation” herein refers to a tensor or a feature vector, which in some sources may be referred to as “embedding”. Part of the neural network model (e.g., the input layer) or a separate neural network model can be used to extract such vector representations from the input raw data. The terms “generation” and “synthesis” may be used interchangeably here.

The text description of the video clip to be generated can be input by the user through any input/output means available on the user's electronic device (e.g., but not limited to, keyboard, microphone, touch screen, mouse, etc.). Alternatively, the text description of the video clip to be generated may be received from any source of text descriptions available on the user's electronic device (e.g., from an application), and the generated video clip may be transmitted back to the source for its subsequent use (e.g. for displaying, processing, etc.) by the source.

After executing step S100, the method proceeds to executing step S105 of obtaining, based on the received text description of the video clip, the vector representation € of the text description. For example, the vector representation of the text description may include the vector representation of the text description according to the vector space of the pre-trained neural network model for binding images and text descriptions. For this, the text description of the video clip to be generated is passed through the text description encoder of the pre-trained neural network model for binding images and text descriptions. At the output, the encoder provides the vector representation e of the text description, obtained according to the vector space of the pre-trained neural network model for binding images and text descriptions, which comprises a vector representation encoding the text description of the entire video clip (e.g., the text description obtained at step S100), and additionally, a sequence of vector representations, each of which encoding the text description of the corresponding frame of the video clip. The non-limiting example of the model for binding images and text descriptions is the CLIP (Contrastive-Language-Image Pre-training) model described in the article published in 2021 “Learning Transferable Visual Models From Natural Language Supervision” by Alec Radford et al., or any derivative or substantially equivalent in functionality machine learning-based neural network model, for example, but not limited to, GLIP (Grounded Language-Image Pre-training) described in the article published in 2021 “Grounded Language-Image Pre-training” by Liunian Harold Li et al., or BLIP-2 (Bootstrapping Language-Image Pre-training) described in the article published on Jun. 15, 2023 “Bootstrapping Language-Image Pre-training with Frozen Image Encoders and Large Language Models” by Junnan Li et al.

The neural network model for binding images and text descriptions comprises the text description encoder and an image encoder. The text description encoder encodes text descriptions into the text description-image vector space, and the image encoder encodes images into the same text description-image vector space. By encoding images and their corresponding text descriptions into the single vector space, binding of image features with corresponding text description features is provided. In this way the model is trained to understand the correspondences between various visual concepts from the real world and the corresponding text descriptions and vice versa. The image encoder can be based on ResNet-50 architecture or on the visual transformer architecture with a self-attention mechanism. The text description encoder can be based on the transformer architecture.

The neural network model for binding images and text descriptions can be trained on pairs (e.g., image, text description) according to the following non-limiting training implementation. An image can be any image, including any frame of any video clip from the training set of video clips, and the corresponding text description is text that describes in words a given frame (for example, its contents, scene, etc.) or the entire video clip (for example, its contents, character, dynamics, scene, etc.) from which the given frame was selected. Given a batch of K pairs (e.g., image, text description), the neural network model for binding images and text descriptions is trained to predict which of the K images×K text descriptions in the batch actually form pairs. To do this, the neural network model for binding images and text descriptions (e.g., CLIP) learns a multimodal vector space of “text descriptions-images” by jointly training the image encoder and the text description encoder in order to maximize the cosine similarity of the vector representations of text descriptions and images of K real pairs in the batch and, at the same time, minimize the cosine similarity of the vector representations K²−K incorrect pairs. The symmetric cross-entropy loss function is then optimized based on these similarity scores.

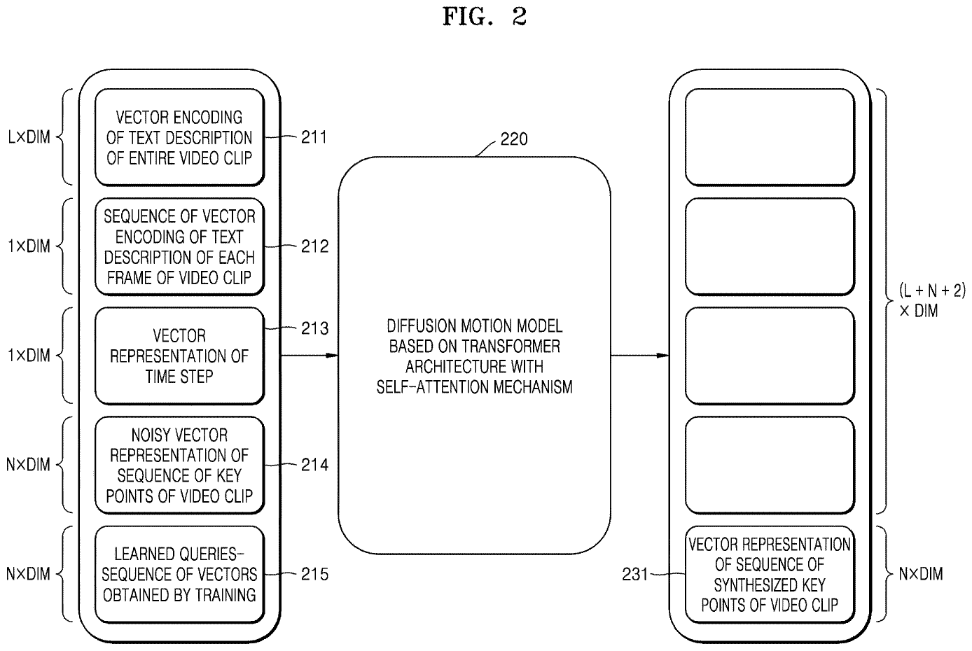

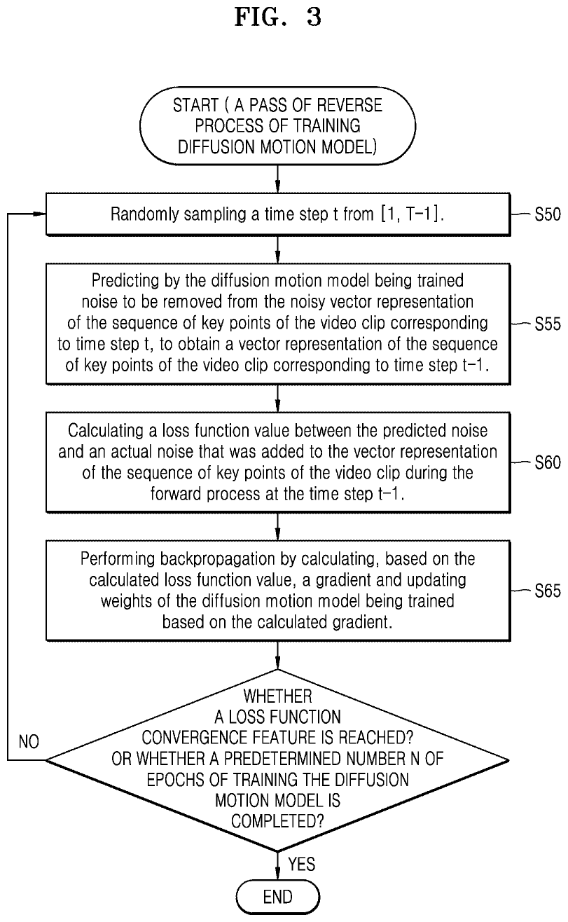

After step S105 is executed, the method proceeds to executing step S110 of obtaining, by the trained diffusion motion model and based on the vector representation e of the text description, a vector representation of a sequence of key points of the video clip being generated. For example, the vector representation of the sequence of the key points may include 2×N×L vector representation, where 2 is the number of coordinates, the first coordinate specifying the frame height H, and the second coordinate specifying the frame width W; N is the number of key points on each frame; and L is the number of frames in the video clip. The vector representation e of the text description supplied to the input of the diffusion motion model serves as a condition for synthesizing the vector representation of the sequence of key points of the video clip. Next, with reference to FIGS. 2 and 3 described are the architecture of the diffusion motion model used, as well as how and on what data this diffusion motion model is trained.

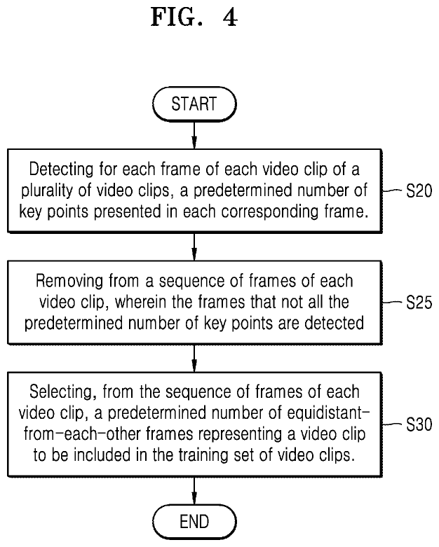

A key point may include a specific point of a person or an object. The key point may include the specific point of a face or body (e.g., joint, facial feature point, tip of a nose, or left elbow.). The key point may include an edge of the object. For example, a set of key points may determine a pose of a person or an object. The following is used as a training data for training the diffusion motion model: a training set generated by the method that is described in detail below with reference to FIG. 4; vector representations e of text descriptions from the training set of video clips, and vector representations of sequences of key points from the training set of video clips. For example, the vector representations of text descriptions from the training set, each video clip from the set of video clips corresponds to text description vector representation e of each video clip that can be obtained by the text description encoder of the trained neural network model for binding images and text descriptions based on at least one frame (for example, the first frame, the last frame, or another frame, or a combination thereof) of the corresponding video clip or based on a text description obtained through manual or automated labelling of training data. For example, the vector representations of sequences of key points from the training set, wherein each video clip from the set of video clips corresponds to vector representation of each video clip of sequence of key points obtained by the trained diffusion motion model based on all frames of the corresponding video clip. For a video clip, a vector representation of a sequence of key points may store the pixel coordinates of a same number of key points for each frame of the video clip, and in different video clips included in the training set of video clips, a number of frames will also be the same (and the same as the number of frames comprised in the training video clips used to train the model), this is achieved through the use of the method for generating training data, which will be described below with reference to FIG. 4.

The diffusion motion model may be referred to as the key point detection model.

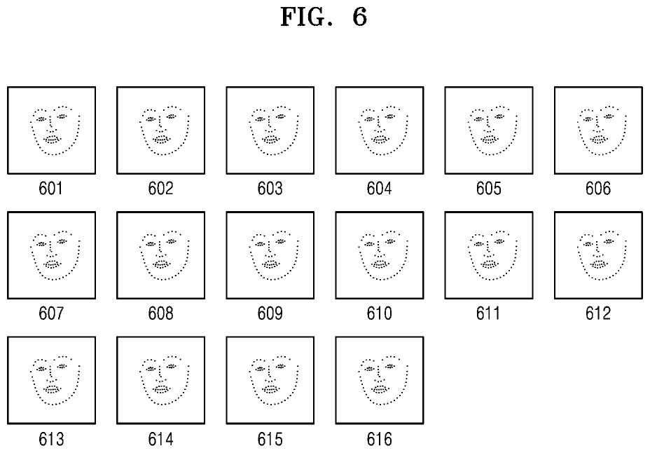

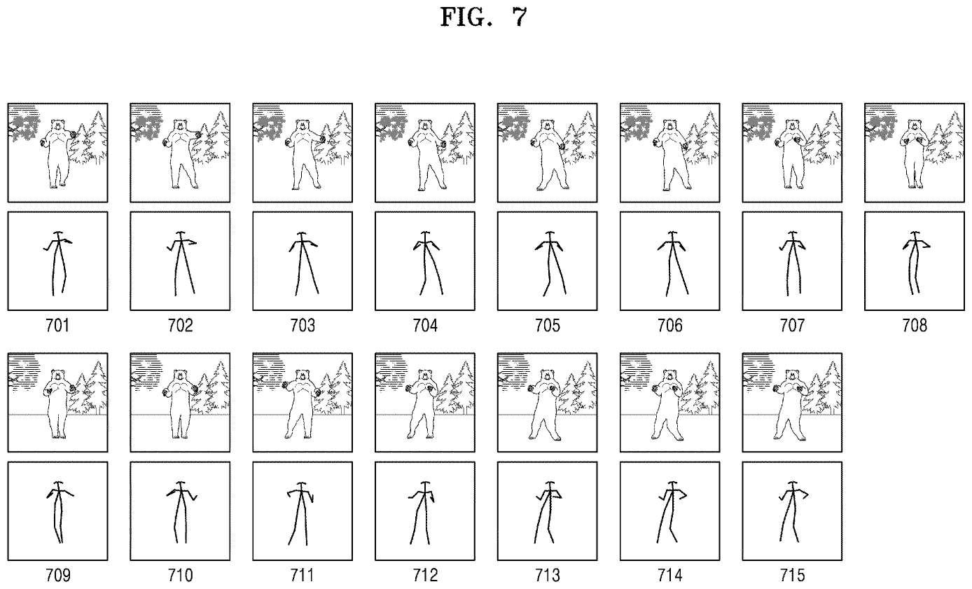

As the key points the diffusion motion model is trained to detect, for each frame of the video clip, key points determining (e.g., defining) a pose of an object (e.g., a person or an animal) in each frame of the video clip. Such key points may comprise at least one of, but are not limited to, one or more key points of object's head, one or more key points of object's body, one or more key points of object's each upper limb, and one or more key points of object's each lower limb (see representations of such key points illustrated in FIG. 7 on a black background under the corresponding frame of the generated video clip). For example, key points of person's head may optionally comprise key points of a person's face defining person's emotion (see representations of such key points for the generated video clip in FIG. 6). The non-limiting example of the key point detection model can be the OpenPose model described in the article published in 2018 “OpenPose: Realtime Multi-Person 2D Pose Estimation using Part Affinity Fields” by Zhe Cao et al., or any derivative or substantially equivalent in functionality machine learning-based neural network model.

The key point detection model may be based on a multi-layer Convolutional Neural Network (CNN) architecture with two branches. The first branch is trained to predict, for a video clip frame, confidence maps of locations of various body parts of one or more people in an original frame of a video clip. The second branch is trained to predict, for a given frame of a video clip, part affinity fields (PAFs), which represent the degree of association between different body parts of one or more people in the original frame of the video clip. The predictions from both branches and the characteristics of the original frame of the video clip are then combined and used to produce predictions of the key points defining the person's pose in the frame of the video clip. To train such a CNN-based key point detection model, one may, but without the limitation, use L₂ loss function calculated between predictions of the confidence maps and part affinity fields produced by the model being trained and the reference (ground truth) confidence maps and part affinity fields. The calculated value of the loss function can then be used to compute gradients and update weights of the model being trained based on the gradients via backpropagation. Non-limiting examples of CNNs applicable herein include VGG-16 or VGG-19.

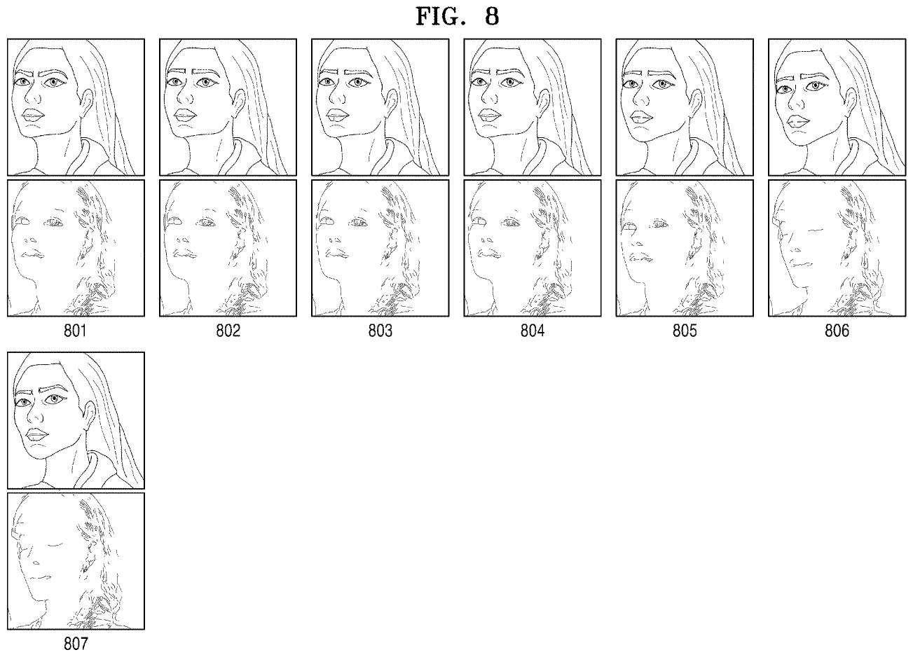

Alternatively, as the key points the diffusion motion model is trained to detect, for each frame of the video clip, key points defining edges of one or more objects in a given frame of the video clip (see representations of such key points for the generated video clip in FIG. 8). Frames in which key points of not all objects are detected, relative to other frames (for example, to temporally adjacent frames) of the same video clip, can be excluded from the sequence of frames. To detect key points in this non-limiting implementation, the Canny edge detector can be used, which is the means of detecting edges of objects in an image, or any means derivative or substantially equivalent to it in functionality, including any machine learning-based neural network or regression model for detecting object edges in the image.

Returning back to the description of the diffusion motion model, which is used at step S110 to obtain a vector representation of the sequence of key points of the generated video clip. Diffusion models are a class of models often used in generative image modeling. According to the accepted formulation, Denoising Diffusion Probabilistic Models (DDPM) are latent variable models of the form p_{θ}(x₀):=ƒp_{θ}(x_{0:T})dx_{1:T} where are hidden variables of similar dimension as the data x₀~q(x₀). Training the diffusion motion model comprises the forward process (also referred to as the diffusion process) and the reverse process (also referred to as the generative process or inverse process), the training is performed iteratively until any of the following training completion conditions are satisfied: a loss function convergence feature is reached and/or a predetermined number N of epochs of training the diffusion motion model is completed. The non-limiting example of reaching the loss function convergence feature may be that over a certain predetermined number of recent training epochs, the absolute difference in the values of the loss function changes less than by a predetermined threshold value (for example, less than by 10⁻⁸). Additionally, training may terminate after a predetermined number of epochs, iterations, or a predetermined time.

The forward process is a Markov chain with Gaussian transitions, usually defined as a sequence of possible events with a finite or countable number of outcomes, where the probability of each event occurring depends on the state reached in the previous event. In the Markov chain-based forward process, Gaussian noise is added to the data according to a data variance schedule β₁, . . . , β_{T}.

$$q ( {x}_{1 : T} \vert {x}_{0} ) := {{\prod }_{t = 1}}^{T} q ( {x}_{t} \vert {x}_{t - 1} ) , \qquad ( Equation 1 )$$

$$q ( {x}_{t} \vert {x}_{t - 1} ) := 𝒩 ( {x}_{t} ; \sqrt{1 - {β}_{t}} {x}_{t - 1} , {β}_{t} I ) , \qquad ( Equation 2 )$$

where
q is the transition function from a noisy representation of a sequence of key points at time step
t, to a less noisy representation of the sequence of key points at step t−1,
xₜ is a representation of the sequence of key points at time step t,
[symbol] represents a normal distribution, and
I represents the identity matrix.

Sampling xₜ for an arbitrary time step t (e.g., for the diffusion process: for t=0 xₜ will be a noise-free vector representation of the sequence of key points from the training data, and for t>0 xₜ will be a noisy vector representation of the sequence of key points from the training data; in general, x is the representation of an image of the sequence of key points in tensor form) during the forward process can be done according to the following Equation 3, presented in closed form:

$$q ( {x}_{t} \vert {x}_{0} ) = 𝒩 ( {x}_{t} ; \sqrt{{\overline{α}}_{t}} {x}_{0} , ( 1 - {\vec{α}}_{t} ) I ) , \qquad ( Equation 3 )$$

where αₜ represents the noisiness degree (e.g., the noise quantity in the representation of the sequence of key points) and is determined as:

$${α}_{t} := 1 - {β}_{t} , \qquad ( Equation 4 )$$

α̅ₜ represents the product of all αₜ, i.e. it is determined as:

$${\overline{α}}_{t} := {{\prod }_{s = 1}}^{t} {α}_{s} . \qquad ( Equation 5 )$$

Thus, during the forward process T diffusion time steps are sequentially performed, at each of which Gaussian noise is added to the vector representation of the sequence of key points of a random video clip from the training data, to obtain noisy vector representations of the sequence of key points of the video clip in number T. In other words, the forward diffusion process adds noise to the vector representation of key point sequence. For example, without using the model performed are T interpolation steps from the vector representation of key point sequence to noise ~N(0, 1). Therefore, the vector representation xₜ of the sequence of key points at the time step t sampled from the range of time steps [0, T−1] is the mixture of the noise-free (original) vector representation of the sequence of key points and the vector representation of random noise for the given time step t (according to the data variance schedule) and is determined as follows:

$${x}_{t} = \sqrt{{\overline{α}}_{t}} {x}_{0} + \sqrt{1 - {\overline{α}}_{t} ϵ} , \qquad ( Equation 6 )$$

where ∈ represents random (added) noise.

The inverse process is a joint distribution p_{θ}(x_{0:T}) also defined as the Markov chain with learned Gaussian transitions between noisy vector representations of the key point sequence and less noisy (up to completely denoised) vector representations of the key point sequence, starting with: p(x_{T})= [symbol] (xₜ;0,l)

$${p}_{θ} ( {x}_{0 : T} ) := p ( {x}_{T} ) {{\prod }_{t = 1}}^{T} {p}_{θ} ( {x}_{t - 1} \vert {x}_{t} ) , \qquad ( Equation 7 )$$

$${p}_{θ} ( {x}_{t - 1} \vert {x}_{t} ) := 𝒩 ( {x}_{t - 1} ; {μ}_{θ} ( {x}_{t} , t ) , {\sum }_{θ} ( {x}_{t} , t ) ) \qquad ( Equation 8 )$$

where μ_{θ} is the expected value of normal distribution. Training during the inverse process is equivalent to learning to remove noise from the noisy vector representation of the sequence of key points xₜ~q(xₜ|xₒ) to obtain an estimate x_{θ}(xₜ)≈x₀ for all time steps, and the estimate in this case is the key point sequence representation from which the predicted noise has been removed.

One pass of the reverse process of training the diffusion motion model is illustrated in FIG. 3. First, a time step t is randomly sampled at step S50 from [1, T−1]. Then, noise that needs to be removed from the noisy vector representation, corresponding to time step t, of the sequence of key points of the video clip is predicted at step S55 by the being-trained diffusion motion model to obtain the vector representation of the sequence of key points of the video clip corresponding to time step t−1. After that, a loss function value between the predicted noise and the actual noise that was added to the vector representation of the sequence of key points of the video clip during the forward process at the time step t−1 is calculated at step S60, and backpropagation is performed at step S65 by calculating, based on the calculated loss function value, a gradient and updating weights of the diffusion motion model being trained based on the calculated gradient.

The loss function value at step S60 is calculated as the Mean Squared Error (MSE) between the predicted noise and the noise actually added to the representation of key points of the video clip at a corresponding time step of the forward process. In other words, the trained diffusion motion model is optimized by minimizing the MSE of the noise prediction according to

$$ℒ = {𝔼}_{e , c} [ {‖ {\hat{ϵ}}_{θ} ( {x}_{t} ) - ϵ ‖}_{2}^{2} ] \qquad ( Equation 9 )$$

over time steps t uniformly sampled from [1, . . . , T], where xₜ is determined according to Equation 6 and \hat{∈}_{θ}(xₜ) is the estimate of added noise ∈, obtained by the diffusion motion model.

The trained diffusion motion model is used (at the inference stage, also referred to in some sources as in-use stage) to obtain, at step S110, the vector representation of the key point sequence of the generated video clip according to the DDPM (denoising) iterative procedure defined as follows:

$${x}_{t - 1} = \frac{1}{\sqrt{{α}_{t}}} ( {x}_{t} - \frac{1 - {α}_{t}}{\sqrt{1 - {\overline{α}}_{t}}} {\hat{ε}}_{θ} ( {x}_{t} , {p}_{enc} , {p}_{emb} , t ) ) , \qquad ( Equation 10 )$$

where \hat{∈}_{θ} represents the trained diffusion motion model with parameters (weights) θ, p_{emb} is the vector representation encoding the text description of the entire video clip according to the vector space of the pre-trained neural network model of binding images and text descriptions,
p_{enc} is the sequence of vector representations, each of which encodes a text description of a corresponding frame of the video clip according to the vector space of the pre-trained neural network model of binding images and text descriptions, and
xₜ is the noisy vector representation of the key point sequence.

To obtain at step S110 the vector representation of the sequence of key points, denoising is iteratively performed according to Equation 10, starting from the time step t=T=[a predetermined value (for example, but not limited to, the mentioned value, 1000)], and until the time step t=0 is reached. The vector representation obtained according to this iterative procedure at time step t=0 is the vector representation of the sequence of key points of the video clip being generated, obtained at step S110.

As schematically shown in FIG. 2 the diffusion motion model is based on the transformer architecture with self-attention mechanism. The transformer having a decoder is used to predict the next token in the input sequence is used as the denoising model in the diffusion process to generate the vector representation of the sequence of key points of the video clip. As shown in FIG. 2, model input data comprise: the vector-encoding of the textual description of the entire video clip 211 (can be referred to as text encoding), the sequence of vector-encodings of textual descriptions of video clip frames 212 (can be referred to as text embedding), the vector representation of the diffusion time step 213 (can be referred to as time embedding), the noisy vector representation of the sequence of key points of the video clip 214 (can be referred to as noised key point sequence), and learned queries that represent the final sequence of vectors obtained by training 215 (can be referred to as learned queries), which allows the transformer to understand what information needs to be extracted from the input sequence in order to predict for each frame and for the corresponding time step t a noise vector that needs to be subtracted from the key point sequence representation to obtain a less noisy (and ultimately noise-free, synthesized) representation of the key point sequence.

The output of the illustrated diffusion motion model based on the transformer architecture with self-attention mechanism 220, namely the vector of the synthesized key point sequence for the video clip, is used at step S115 to obtain a series of images (e.g., two-dimensional, three-dimensional) of key points of the video clip being generated. All input data presented in vector form are projected to the same dimension, for example, (f)=512 using trainable linear layers that provide a linear transformation on the input data, and then concatenated into a single vector representation of the sequence of length L+2+N+N, where L is the number of frames in the video clip, N is the number of key points on each frame. This vector representation of the input data sequence is then processed by the transformer model, which outputs a sequence having the same shape as the input sequence ((L+2+N+N)×dimension), the last N×dimension (that could be 2×L) vectors in the vector representation of the output sequence correspond to the synthesized vector representation 2×N×L of the sequence of key points. These 2×N×L last vectors are then further projected into a predefined key point dimension via the trained output projecting linear layer. As the result, the transformer architecture disclosed herein may have the following trainable parts: the transformer itself, input projecting linear layers, output projecting linear layer, and a sequence of vectors obtained by training. All these elements are trained end-to-end using the MSE loss function defined according to Equation 9 above.

The decoder of the transformer illustrated in FIG. 2 comprises a predetermined number M of consecutive blocks, each of which includes a Multi-Head Self-Attention (MHSA) component and a Multi-Layer Perceptron (MLP) component. In the non-limiting implementation example, M=12. The self-attention mechanism was proposed along with the first transformer architecture in the article published in 2017 “Attention Is All You Need” by Ashish Vaswani et al. The key function of this mechanism is that higher level features accumulate information from all elements of the sequence of lower level features. The operation of single-head self-attention is defined as follows:

$${A}_{h} = SoftMax ( \frac{{Q}_{h} {K}_{h}^{T}}{\sqrt{d}} ) {V}_{h} \qquad ( Equation 11 )$$

where Qₕ is the query matrix and is calculated as

$${Q}_{h} = X {W}_{Q}^{h} , \qquad ( Equation 12 )$$

where X is the representation of the input sequence,

$${W}_{Q}^{h}$$

is the matrix of weights of queries, which is obtained by training,
Kₕ is the key matrix and is calculated as

$${K}_{h} = X {W}_{K}^{h} \qquad ( Equation 13 )$$

where X is the representation of the input sequence,

$${W}_{k}^{h}$$

is the matrix of weights of keys, which is obtained by training,
Vₕ is the value matrix and is calculated as

$${V}_{h} = {XW}_{V}^{h} , \qquad ( Equation 14 )$$

where X is the representation of the input sequence,

$${W}_{V}^{h}$$

is the matrix of weights of values, which is obtained by training,
\sqrt{d} is a normalization constant defined as the square root of the dimension of keys and values.

By multiplying the representation xᵢ of each element of the input sequence by

$${W}_{Q}^{h} , {W}_{K}^{h} , {W}_{V}^{h} ,$$

row vectors qᵢ, kᵢ, vᵢ are obtained, where i represents the element number, which are respectively called queries, keys, and values. Their roles can be described, for clarity, as follows: qᵢ is the query to the database; kᵢ are keys of values stored in the database, on which the search will be carried out; and vᵢ are the values themselves. Thus, the matrices

$${W}_{Q}^{h} , {W}_{K}^{h} , and {W}_{V}^{h} ∈ \text{?}$$

project the input sequence X∈ [symbol] into an output tensor having dimension d, sequence length N and the original dimension of the sequence element vector representation f=512. In other words, upon applying the matrices

$${W}_{Q}^{h} , {W}_{K}^{h} , {W}_{V}^{h}$$

to the input sequence X, three sequences of length N having the reduced dimension d (f is the original dimension of the vectors in the sequence) are obtained. The attention matrix defined in Equation 11 as

$${Q}_{h} {K}_{h}^{T}$$

is responsible for learning correspondence estimates between tokens in the sequence. According to the above, the proximity of a query qᵢ to a key kᵢ can be determined as the dot product between each element/token in the query matrix (Qₕ) and each element/token in the key matrix (Kₕ). The operation of single-head self-attention results in a process of self-supported matching, whereby the tokens of the input sequence learn to accumulate information from each other.

Self-attention is often used in a multi-head attention mode (e.g., with a plurality attention heads, also referred to in some sources as “attention foci”). The use of this mode improves the model's ability to focus on different positions of the sequence being processed and provides multiple “representational subspaces” for the attention layer. In this scenario, the transformer architecture illustrated in FIG. 2, can use, but without limitation, H=8 parallel attention heads with independent matrices

$${W}_{Q}^{h} , {W}_{K}^{h} , {W}_{V}^{h} ,$$

of weights. The output of the attention heads are then concatenated and multiplied by a weight matrix W₀∈ [symbol] that maps the concatenated outputs to match the output shape according to the following:

$$O = {W}_{O} \times concat {( {A}_{1} , {A}_{2} , … , {A}_{H} )}^{T} , \qquad ( Equation 15 )$$

where A_{H} represents the output of the corresponding attention head H. In other words, Wₒ is the trainable weight matrix responsible for projecting the obtained data into the dimension of the output sequence, e.g. from d to f.

In addition to the attention sublayers, each of the transformer decoder layers comprises a fully connected feed-forward network (Multilayer Perceptron, MLP) that is applied in the same manner to each token (e.g., to r vector in the sequence) individually. This MLP comprises two linear transform components with a GELU (Gaussian Error Linear Unit) activation component between them. Such MLP expands the token dimension f=512 to the dimension fₕ=2048, applies the GELU-induced nonlinearity to it, and projects fₕ back to f:

$$MLP ( x ) = GELU ( {xW}_{1} + {b}_{1} ) {W}_{2} + {b}_{2} , \qquad ( Equation 16 )$$

where W₁, b₁, W₂, b₂ represent the parameters of the first and second linear layer, respectively.

The purpose of this manipulation performed by the MLP is to capture high-level features in the token feature map. GELU activation in Equation 16 should be considered as the preferred activation function for the MLP, but the embodiment of the disclosure should not be limited only to this activation function since other activation functions may well be used in other embodiments, for example, ReLU (Rectified Linear Activation Unit) or ELU (Exponential Linear Unit).

Thus, the transformer architecture described above is used in the embodiment of the disclosure not for its intended purpose because it is fed not with an ordered sequence [x0, x1, x2, x3], but with an unordered set of different variables [p_{enc} 211, p_{emb} 212, . . . time_emb 213, noised_sequence 214, learned_queries 215], and the self-attention mechanism essentially writes into each output element a weighted sum of the remaining elements. In the embodiment of the disclosure, the last element of the sequence at the transformer output is the vector representation of the sequence of key points generated at step S110. The transformer weights obtained by training depend on which element was in the sequence at the input to the transformer. In other words, learned_queries 215 are a sequence of learnable vectors (bottom left in FIG. 2) that allow the transformer to understand how to correctly combine the information from [p_{enc} 211, p_{emb} 212, . . . time_emb 213, noised_sequence 214, learned_queries 215]] to predict the noise to be subtracted from the noised_sequence at a time step corresponding to time_emb to synthesize the required vector representation of the key point sequence.

Moreover, it is fair to note that what is shown in FIG. 2 is applicable as the illustration of both the learning stage and the inference stage. In other words, the vector representation e of the text description of the video clip, the representation of the key points of which is currently used in training the diffusion motion model, is further fed to the input of the diffusion motion model being trained, with which the inverse process is currently performed, as the condition for training the diffusion motion model taken into account through the self-attention mechanism. Similarly, when using the already trained diffusion motion model, the vector representation e of the text description of the video clip to be generated is fed at step S110 to the input of the diffusion motion model as the condition for obtaining the vector representation of the sequence of key points of the video clip to be generated, which is taken into account through the self-attention mechanism of the trained diffusion motion model. Returning to the description of FIG. 1 after the vector representation of the sequence of key points of the video clip to be generated, including p_{enc} and p_{emb}, is obtained at step S110, the method proceeds to step S115 of mapping the vector representation of the sequence of key points of the video clip being generated to a series of key point (e.g., two-dimensional) images of the video clip being generated. Each image of key points from the series corresponds to a respective frame of the video clip being generated. Non-limiting illustrations of the two-dimensional key point images generated at this step are shown in FIG. 6, and also in FIGS. 7 and 8, where such 2D images of key points are shown on a black background under the corresponding frame of the generated video clip. The choice of black color for the background of key point images is not the limitation as long as pixels of key points are highlighted in these images in any (preferably highly-contrast) manner from all other pixels of these images. Thus, in the other non-limiting example, the background color may be white and the key point pixel shading color may be black.

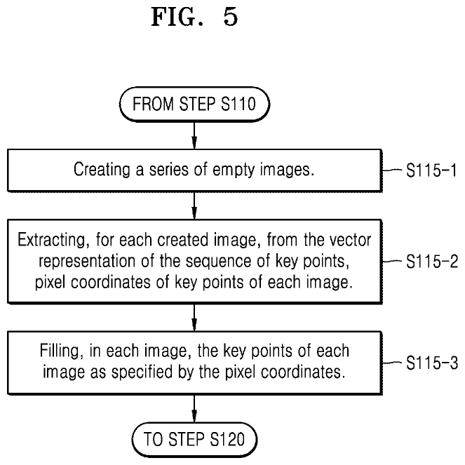

The non-limiting implementation of this step S115 is described below with reference to FIG. 5. Mapping S115 the vector representation of the sequence of key points of the generated video clip into the series of L key point images (e.g., two-dimensional) begins with the execution of step S115-1 of creating a series of L empty images. For example, the series of L empty images may include images H×W, where H is the image height, W is the image width. The number L corresponds to the number of frames of the generated video clip and the number of frames of each video clip in the used training set of video clips. The values of H and W respectively correspond to the height and width of each frame of the generated video clip, as well as the height and width of each frame of each video clip in the used training set of video clips. Then, the mapping proceeds to step S115-2 of extracting, for each created image, from the representation of the sequence of key points, pixel coordinates of N key points of the corresponding image. According to the configuration of the diffusion motion model that was used to collect the training data, or according to the structure of the key points in the training data itself, one key point may be represented by a single pixel, or alternatively, one key point may be represented by several or even multiple pixels. Therefore, this should not be interpreted as the limitation of the embodiment of the disclosure. Finally, after step S115-2 is performed, the mapping S115 proceeds to step S115-3 of filling, in each image of the series of L images, pixels of the N key points of the corresponding image as specified by the pixel coordinates. In this case, “filling” itself should be interpreted here in a broad sense as “highlighting” of pixels of N key points (including any modification of chrominance or intensity values of these pixels) specified by the coordinates, relative to all other pixels in the image.

Returning to the description of FIG. 1, once the vector representation of the sequence of key points of the video clip being generated is mapped at step S115 to the series of L key point images (e.g., two-dimensional) of the video clip being generated, the method proceeds to step S120 of generating a frame sequence of the video clip using a pre-trained stable diffusion model. In that, the generation of each frame of the video clip by the stable diffusion model is further controlled by a controlling neural network model based on the image of key points of the respective frame from the series of L key point images, obtained at the previous step S115. In the non-limiting implementation example, the diffusion generator of Stable Diffusion (SD) described in the article published in 2021 “High-Resolution Image Synthesis with Latent Diffusion Models” by Robin Rombach et al. or any derivative or substantially equivalent in functionality diffusion generator can be used as the stable diffusion model applied at this step. The controlling neural network model applied at this step can be the ControlNet model described in the article published in 2023 “Adding Conditional Control to Text-to-Image Diffusion Models” by Lvmin Zhang et al. or any derivative or substantially equivalent in functionality neural network model. Non-limiting examples of frames thus generated are shown in FIG. 7 and FIG. 8, see namely the corresponding frames shown in these figures above the corresponding two-dimensional images of the key points, which served at step S120 as the conditions of synthesizing the corresponding frames of the video clip, which were taken into account, through the controlling neural network model, by the stable diffusion model.

Let's now turn to the description of FIG. 4, which illustrates the flowchart of generating the training set used for training the diffusion motion model described above with reference to FIG. 2 and FIG. 3. The generation of the training set of video clips begins from the execution of step S20 of detecting, by the diffusion motion model and on each frame of each video clip of a plurality of video clips, a predetermined number N of key points. The predetermined number of key points may determine (e.g., define) a pose of an object (e.g., person or animal) and/or edges of one or more objects presented in a given frame. Then, at step S25 from a sequence of frames of each video clip from the plurality of video clips removed are those frames for which not all N key points are detected by the diffusion motion model. For example, the predetermined number N of key points defining the pose of the object (e.g., person or animal) and/or edges of one or more objects. Step S25 may be necessary to filter the several key points that may be missing (e.g., occlusion or other reasons).

As the non-limiting exemplary implementation of this step, from the sequence of frames of each video clip from the plurality of video clips, those frames may be removed in which a number of pixels representing key points detected by the diffusion motion model differs from a number of pixels representing the key points on frames already processed by the diffusion motion model by a predetermined amount. This implementation can be applied when for detecting edges of objects in images the Canny edge detector is used as the diffusion motion model. In a non-limiting exemplary implementation of this step, if the pose/placement of any object (including a person) in the image should, according to the pre-configuration of the trained key point detection model, be defined by, for example, a predetermined number of key points, e.g. 16 key points as shown in each two-dimensional image of key points in FIG. 7 for images of the dancing bear, then only those frames in which all 16 key points of this object are detected can be selected from the sequence of frames, and those frames in which not all these 16 key points of the object are detected can be removed from the sequence of frames.

Let's return to the description of the sequence of steps in FIG. 4. At the final step S30 a predetermined number L of equidistant-from-each-other frames representing the video clip to be included in the training set of video clips are selected from the sequence of remaining frames of each video clip from the plurality of video clips. As mentioned above, the number L corresponds to the number of frames of the generated video clip and to the number of frames of each video clip in the applied training set of video clips. Additionally, the L two-dimensional images of video clip key points can be further processed by an exponential moving average with a window size equal to n two-dimensional images of video clip key points, where n<L. Any other type of moving average can be used in place of the exponential moving average. This additional processing applied to the diffusion motion model training stage according to the diagram shown in FIG. 1, or to the inference stage according to the pipeline, allows to avoid sudden movements or jerks of objects in the frames of the generated video clip.

Any aspects of any of the neural network models described above can be implemented in practice using machine learning libraries such as, for example, but not limited to, Tensorflow, Pytorch, Keras. Training of any of the neural network models described above can be carried out online, i.e. on the same device on which the trained model is subsequently used, or offline, i.e. on another device (for example, on a computer server adapted to efficiently carry out such training). Additionally, the inference of the trained neural network model pipeline detailed above and illustrated with reference to FIG. 1 can also be performed online, when the weights and parameters of the neural network models are loaded and used directly on the end user's electronic device, or offline, when the end user sends a request (for example, through an application) in the form of a text description of the video clip to be generated, to one or more computer servers that store weights and other parameters of neural network models, including, optionally, the sequence of vectors obtained by training, as well as computer-executable instructions for executing these neural network models on demand, and in response receives a generated video clip.

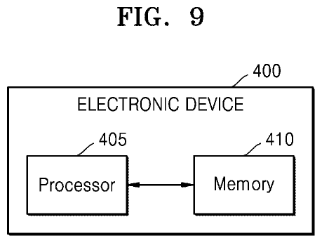

Therefore, the embodiment of the disclosure also provides an electronic device 400, schematically shown in FIG. 9, which may be any one of the above-mentioned user's electronic device or the above-mentioned computer server. The electronic device may be configured to implement any of the above-described aspects of the embodiment of the disclosure or developments thereof. The electronic device comprises at least one processor 405 and at least one memory 410 that stores computer-executable instructions, as well as weights and parameters of the neural network models of the processing pipeline proposed herein and shown in FIG. 1. When the electronic device 400 is the user electronic device, the user electronic device may be, but is not limited to, a mobile phone, a smartphone, a tablet, a laptop, a personal computer, a user's wearable electronic device (e.g., glasses, watches), an AR/VR headset, Internet of Things (IoT) device, in-vehicle equipment, or any other electronic device capable of mobile or other communications. The user electronic device may be differently referred to as the user terminal, user device, subscriber equipment, etc.

The electronic device 400 is shown in FIG. 9 in a relatively simplified, schematic form, so that the figure does not show all the components actually comprised therein, but only those by which the embodiment of the disclosure can be implemented. As is known, the electronic device may comprise other components not shown in FIG. 9, for example, power supply, battery, various interfaces, input/output means, communication module, various interconnects, as well as any suitable operating system (Windows, Linux, Android, IOS, HarmonyOS, etc.) and so on. The communication module may comprise a transceiver and an antenna coupled to each other.

The processor 405 of the electronic device UE 400 may be a central processing unit, a special purpose processor, another processing unit such as a graphics processing unit (GPU), a neural processor, or a combination thereof. The processor 405 may be implemented as a chip, such as FPGA, ASIC, SoC, etc. The memory 410 may include random access memory and read-only memory storing processor-executable instructions, as well as weights and parameters, including, optionally, the vectors obtained by training, of the neural network models illustrated in FIG. 1 for generation of video clips from text descriptions.

The random access memory may include random access memory of any class, such as, but not limited to, FB DIMM (Fully Buffered DIMM), DDR SDRAM REG (Registered) ECC, DDR3 SDRAM, DDR2 SDRAM, DDR SDRAM, RDRAM (RIMM, Rambus), SRAM, ESDRAM, SDRAM, SO-DIMM, DIMM, SIMM. The read-only memory may include the read-only memory of any class, such as, but not limited to, MROM, PROM, EPROM, EEPROM, EAROM. The read-only memory can be implemented as, but not limited to, flash memory, HDD, SSD.

The embodiment of the disclosure further provides a computer-readable medium storing computer-executable instructions, as well as weights and parameters, including, optionally, the sequence of vectors obtained by training, of neural network models of the processing pipeline proposed herein and shown in FIG. 1. The instructions, when executed by a device equipped with at least the processor and the memory, cause the device to generate a video clip from a text description, which can subsequently be displayed on a screen or transmitted for any purpose to any other source located either within the device itself or outside the device, for example, over a communication network. The computer-readable medium may be any non-transitory computer-readable medium, memory, storage area, storage device, etc., such as, but not limited to, a hard disk drive, optical media, semiconductor media, Solid-State Drive (SSD), or similar to them.

The technical solutions disclosed in this application enables synthesis of a video clip from a text description without using real reference video clips at the inference stage. In addition, the technical solutions disclosed in this application make it possible to obtain synthetic training data in the form of generated video clips corresponding to required text descriptions in any required volume. These synthetic video clips can be used to train any other neural network models. Moreover, the quality of video clips generated according to the embodiment of the disclosure is not inferior to the quality of video clips generated by technical solutions known from the prior art that use, at the inference stage, real reference videos. Sufficiently high quality of generated video clips is ensured through the use of namely diffusion models both for synthesizing the sequence of key points and for generating the final video clip based on the synthesized sequence of its key points corresponding to the user's request.

One skilled in the art will appreciate that the various illustrative logical blocks (functional blocks or modules) and steps (operations) used in embodiments of the disclosed technical solution may be implemented by electronic hardware, computer software, or a combination thereof. Whether the functions are implemented by using hardware or software depends on particular applications and requirements to a design of an entire system. A person skilled in the art may use different methods to implement the described functions for each particular application, but it should not be considered that such an implementation will go beyond the scope of the embodiments disclosed in the application.

It should also be noted that the order of steps of any disclosed method is not strict, because some one or more steps may be rearranged in the actual order of execution and/or combined with another one or more steps, and/or divided into a larger number of sub-steps.

Throughout this application, reference to an element in the singular form does not preclude the presence of a plurality of such elements in the actual implementation of the invention, and, conversely, reference to an element in the plural form does not exclude the presence of only one such element in the actual implementation of the invention. Any specific value or a range of values specified above should not be interpreted in a limiting sense, but rather such a specific value or a range of values should be considered to represent the midpoint of the specified larger range, up to approximately 50% on either side of the specified value or specified boundaries of a smaller range. If this application states that any element “comprises” or “includes” a number of components, that number of components should not be interpreted as the only contents of that element. Instead, the specified element may “comprise” or “include” other components that are not listed explicitly.

While this disclosure has been made and described with reference to specific embodiments and examples thereof, those skilled in the art will understand that various modifications in form and content may be made without departing from the spirit and scope of this disclosure as defined by the appended claims and their equivalents. In other words, the foregoing detailed description is based on specific examples and possible non-limiting implementations of the embodiment of the disclosure, but it should not be interpreted to mean that only the explicitly disclosed implementations are feasible. It is intended that any modification or substitution that could be made to this disclosure by one of ordinary skill in the art without creative and/or technical contribution shall be within the scope of protection (with equivalents considered) provided by the following claims.

According to an embodiment of the disclosure, a method performed by an electronic device may include receiving the text description of the video clip to be generated. According to an embodiment of the disclosure, a method performed by an electronic device may include obtaining, based on the received text description, a vector representation of the text description. According to an embodiment of the disclosure, a method performed by an electronic device may include obtaining a vector representation of a sequence of key points of the video clip to be generated, by a diffusion motion model based on the obtained vector representation of the text description. According to an embodiment of the disclosure, a method performed by an electronic device may include mapping the vector representation of the sequence of key points to a series of key point images of the video clip being generated, wherein each key point image from the series corresponding to a respective frame of the video clip being generated. According to an embodiment of the disclosure, a method performed by an electronic device may include generating a frame sequence of the video clip.

According to an embodiment of the disclosure, a method performed by an electronic device may include receiving the text description of the video clip to be generated. According to an embodiment of the disclosure, a method performed by an electronic device may include obtaining, based on the received text description of the video clip, a vector representation of the text description according to the vector space of the pre-trained neural network model for binding images and text descriptions. According to an embodiment of the disclosure, a method performed by an electronic device may include obtaining a 2×N×L vector representation of a sequence of key points of the video clip to be generated, by a diffusion motion model based on the obtained vector representation of the text description, where 2 is the number of coordinates, the first coordinate specifying the frame height H, and the second coordinate specifying the frame width W; N is the number of key points on each frame; and L is the number of frames in the video clip. According to an embodiment of the disclosure, a method performed by an electronic device may include mapping the vector representation of the sequence of key points to a series of L two-dimensional key point images of the video clip being generated, wherein each two-dimensional key point image from the series corresponding to a respective frame of the video clip being generated. According to an embodiment of the disclosure, a method performed by an electronic device may include generating a frame sequence of the video clip using a pre-trained stable diffusion model. According to an embodiment of the disclosure, the generation of each frame of the video clip by the stable diffusion model may be further controlled by a controlling neural network model based on the two-dimensional key point image of the respective frame from the series.

According to an embodiment of the disclosure, input data corresponding to the diffusion motion model may comprises vector encoding of the text description, sequence of vector encodings of text descriptions of each frame of video clip, vector representation of diffusion time step, noisy vector representation of the sequence of key points of video clip, and learned quarries.

According to an embodiment of the disclosure, the diffusion motion model may be trained with training data. According to an embodiment of the disclosure, the training data may comprise vector representations of text descriptions from a training set, and vector representations of sequences of key points from the training set.

According to an embodiment of the disclosure, the diffusion motion model may be trained to detect, as the key points for each frame of the video clip to be generated, the key points that define a pose of an object in each frame of the video clip to be generated.

According to an embodiment of the disclosure, the key points defining the pose of the object may comprise at least one of one or more key points of object's head, one or more key points of object's body, one or more key points of object's each upper limb, or one or more key points of object's each lower limb.

According to an embodiment of the disclosure, the key points defining the pose of the object may comprise at least one of one or more key points of person's head, one or more key points of person's body, one or more key points of person's each upper limb, or one or more key points of person's each lower limb.

According to an embodiment of the disclosure, the key points of object's head may comprise key points of object's face that define object's emotion.

According to an embodiment of the disclosure, the key points of person's head may comprise key points of person's face that define person's emotion.

According to an embodiment of the disclosure, the key point detection model may be trained to detect, as the key points for each frame of the video clip, key points that define edges of one or more objects in a given frame of the video clip.

According to an embodiment of the disclosure, the diffusion motion model may comprise a forward process and a reverse process. According to an embodiment of the disclosure, the diffusion motion model may be performed iteratively until at least one of a loss function convergence feature is reached, or a predetermined number of epochs of training the diffusion motion model is completed.

According to an embodiment of the disclosure, during the forward process T diffusion time steps are sequentially performed, at each of which Gaussian noise is added to the vector representation of the sequence of key points, to obtain noisy vector representations of the sequence of key points of the video clip in the T diffusion time steps.

According to an embodiment of the disclosure, during the reverse process the diffusion motion model may be trained. According to an embodiment of the disclosure, a method performed by an electronic device may include randomly sampling a time step t from [1, T−1]. According to an embodiment of the disclosure, a method performed by an electronic device may include predicting by the diffusion motion model being trained noise to be removed from the noisy vector representation of the sequence of key points of the video clip corresponding to time step t, to obtain a vector representation of the sequence of key points of the video clip corresponding to time step t−1. According to an embodiment of the disclosure, a method performed by an electronic device may include calculating a loss function value between the predicted noise and an actual noise that was added to the vector representation of the sequence of key points of the video clip during the forward process at the time step t−1. According to an embodiment of the disclosure, a method performed by an electronic device may include performing backpropagation by calculating, based on the calculated loss function value, a gradient and updating weights of the diffusion motion model being trained based on the calculated gradient.

According to an embodiment of the disclosure, the loss function value may be calculated as the Mean Squared Error (MSE) between the predicted noise and the noise actually added to the representation of key points of the video clip at a given time step of the forward process.

According to an embodiment of the disclosure, the diffusion motion model may be based on a transformer architecture with a self-attention mechanism.

According to an embodiment of the disclosure, the vector representation of the text description of the video clip, the representation of the key points of which is currently used in training the diffusion motion model, may be further fed to the input of the diffusion motion model being trained, with which the inverse process is currently performed, as the condition for training the diffusion motion model taken into account through the self-attention mechanism.

According to an embodiment of the disclosure, a method performed by an electronic device may include detecting for each frame of each video clip of a plurality of video clips, a predetermined number of key points presented in each corresponding frame. According to an embodiment of the disclosure, a method performed by an electronic device may include removing from a sequence of frames of each video clip, wherein the frames that not all the predetermined number of key points are detected. According to an embodiment of the disclosure, a method performed by an electronic device may include selecting, from the sequence of frames of each video clip, a predetermined number of equidistant-from-each-other frames representing a video clip to be included in the training set of video clips.

According to an embodiment of the disclosure, a method performed by an electronic device may include creating a series of empty images. According to an embodiment of the disclosure, a method performed by an electronic device may include extracting, for each created image, from the vector representation of the sequence of key points, pixel coordinates of key points of each image. According to an embodiment of the disclosure, a method performed by an electronic device may include filling, in each image, the key points of each image as specified by the pixel coordinates.

According to an embodiment of the disclosure, a method performed by an electronic device may include creating a series L of empty images H×W, where His the image height, W is the image width. According to an embodiment of the disclosure, a method performed by an electronic device may include extracting, for each created image, from the vector representation of the sequence of key points, pixel coordinates of key points of each image. According to an embodiment of the disclosure, a method performed by an electronic device may include filling, in each image, the key points of each image as specified by the pixel coordinates.

According to an embodiment of the disclosure, a method performed by an electronic device may include processing L two-dimensional key point images of the video clip with a moving average having a window size equal to n two-dimensional key point images of the video clip, where n<L.

According to an embodiment of the disclosure, the vector representation of the text description, obtained according to the vector space of the pre-trained neural network model for binding images and text descriptions, may comprise a vector representation encoding the text description of the entire video clip, and a sequence of vector representations, each of which encodes the text description of the corresponding frame of the video clip.

According to an embodiment of the disclosure, an electronic device comprising one or more processors and memory for storing computer instructions is provided. According to an embodiment of the disclosure, the non-transitory computer-readable storage medium storing computer-executable instructions which, when executed by at least one processor, may cause the at least one processor to at least to receive the text description of the video clip to be generated. According to an embodiment of the disclosure, the computer-readable medium storing computer-executable instructions that, when executed by at least one processor, may cause the device to obtain, based on the received text description, a vector representation of the text description. According to an embodiment of the disclosure, the computer-readable medium storing computer-executable instructions that, when executed by at least one processor, may cause the device to obtain a vector representation of a sequence of key points of the video clip to be generated, by a diffusion motion model based on the obtained vector representation of the text description. According to an embodiment of the disclosure, the computer-readable medium storing computer-executable instructions that, when executed by at least one processor, may cause the device to map the vector representation of the sequence of key points to a series of key point images of the video clip being generated, wherein each key point image from the series corresponding to a respective frame of the video clip being generated. According to an embodiment of the disclosure, the computer-readable medium storing computer-executable instructions that, when executed by at least one processor, may cause the device to generate a frame sequence of the video clip.

According to an embodiment of the disclosure, the computer-readable medium storing computer-executable instructions that, when executed by at least one processor, may cause the device to receive the text description of the video clip to be generated. According to an embodiment of the disclosure, the computer-readable medium storing computer-executable instructions that, when executed by at least one processor, may cause the device to obtain, based on the received text description of the video clip, a vector representation of the text description according to the vector space of the pre-trained neural network model for binding images and text descriptions. According to an embodiment of the disclosure, the computer-readable medium storing computer-executable instructions that, when executed by at least one processor, may cause the device to obtain a 2×N×L vector representation of a sequence of key points of the video clip to be generated, by a diffusion motion model based on the obtained vector representation of the text description, where 2 is the number of coordinates, the first coordinate specifying the frame height H, and the second coordinate specifying the frame width W; N is the number of key points on each frame; and L is the number of frames in the video clip. According to an embodiment of the disclosure, the computer-readable medium storing computer-executable instructions that, when executed by at least one processor, may cause the device to map the vector representation of the sequence of key points to a series of L two-dimensional key point images of the video clip being generated, wherein each two-dimensional key point image from the series corresponding to a respective frame of the video clip being generated. According to an embodiment of the disclosure, the computer-readable medium storing computer-executable instructions that, when executed by at least one processor, may cause the device to generate a frame sequence of the video clip using a pre-trained stable diffusion model. According to an embodiment of the disclosure, the generation of each frame of the video clip by the stable diffusion model may be further controlled by a controlling neural network model based on the two-dimensional key point image of the respective frame from the series.

According to an embodiment of the disclosure, during the reverse process the diffusion motion model may be trained. According to an embodiment of the disclosure, the computer-readable medium storing computer-executable instructions that, when executed by at least one processor, may cause the device to randomly sample a time step t from [1, T−1]. According to an embodiment of the disclosure, the computer-readable medium storing computer-executable instructions that, when executed by at least one processor, may cause the device to predict by the diffusion motion model being trained noise to be removed from the noisy vector representation of the sequence of key points of the video clip corresponding to time step t, to obtain a vector representation of the sequence of key points of the video clip corresponding to time step t−1. According to an embodiment of the disclosure, the computer-readable medium storing computer-executable instructions that, when executed by at least one processor, may cause the device to calculate a loss function value between the predicted noise and an actual noise that was added to the vector representation of the sequence of key points of the video clip during the forward process at the time step t−1. According to an embodiment of the disclosure, the computer-readable medium storing computer-executable instructions that, when executed by at least one processor, may cause the device to perform backpropagation by calculating, based on the calculated loss function value, a gradient and updating weights of the diffusion motion model being trained based on the calculated gradient.

According to an embodiment of the disclosure, the computer-readable medium storing computer-executable instructions that, when executed by at least one processor, may cause the device to detect for each frame of each video clip of a plurality of video clips, a predetermined number of key points presented in each corresponding frame. According to an embodiment of the disclosure, the computer-readable medium storing computer-executable instructions that, when executed by at least one processor, may cause the device to remove from a sequence of frames of each video clip, wherein the frames that not all the predetermined number of key points are detected. According to an embodiment of the disclosure, the computer-readable medium storing computer-executable instructions that, when executed by at least one processor, may cause the device to select, from the sequence of frames of each video clip, a predetermined number of equidistant-from-each-other frames representing a video clip to be included in the training set of video clips.

According to an embodiment of the disclosure, the computer-readable medium storing computer-executable instructions that, when executed by at least one processor, may cause the device to create a series of empty images. According to an embodiment of the disclosure, the computer-readable medium storing computer-executable instructions that, when executed by at least one processor, may cause the device to extract, for each created image, from the vector representation of the sequence of key points, pixel coordinates of key points of each image. According to an embodiment of the disclosure, the computer-readable medium storing computer-executable instructions that, when executed by at least one processor, may cause the device to fill, in each image, the key points of each image as specified by the pixel coordinates.

According to an embodiment of the disclosure, the computer-readable medium storing computer-executable instructions that, when executed by at least one processor, may cause the device to create a series L of empty images H×W, where H is the image height, Wis the image width. According to an embodiment of the disclosure, the computer-readable medium storing computer-executable instructions that, when executed by at least one processor, may cause the device to extract, for each created image, from the vector representation of the sequence of key points, pixel coordinates of key points of each image. According to an embodiment of the disclosure, the computer-readable medium storing computer-executable instructions that, when executed by at least one processor, may cause the device to fill, in each image, the key points of each image as specified by the pixel coordinates.

According to an embodiment of the disclosure, the computer-readable medium storing computer-executable instructions that, when executed by at least one processor, may cause the device to process L two-dimensional key point images of the video clip with a moving average having a window size equal to n two-dimensional key point images of the video clip, where n<L.

According to an embodiment of the disclosure, a computer-readable medium storing computer-executable instructions is provided. According to an embodiment of the disclosure, the instruction that, when executed by the processor, may cause the device to receive the text description of the video clip to be generated. According to an embodiment of the disclosure, the instruction that, when executed by the processor, may cause the device to obtain, based on the received text description, a vector representation of the text description. According to an embodiment of the disclosure, the instruction that, when executed by the processor, may cause the device to obtain a vector representation of a sequence of key points of the video clip to be generated, by a diffusion motion model based on the obtained vector representation of the text description. According to an embodiment of the disclosure, the instruction that, when executed by the processor, may cause the device to map the vector representation of the sequence of key points to a series of key point images of the video clip being generated, wherein each key point image from the series corresponding to a respective frame of the video clip being generated. According to an embodiment of the disclosure, the instruction that, when executed by the processor, may cause the device to generate a frame sequence of the video clip.

1. A method of generating a video clip from a text description, the method comprising:
receiving the text description of the video clip to be generated,
obtaining, based on the received text description, a vector representation of the text description,
obtaining a vector representation of a sequence of key points of the video clip to be generated, by a diffusion motion model based on the obtained vector representation of the text description,
mapping the vector representation of the sequence of key points to a series of key point images of the video clip being generated, wherein each key point image from the series corresponding to a respective frame of the video clip being generated, and
generating a frame sequence of the video clip.

2. The method of claim 1, wherein input data corresponding to the diffusion motion model comprises: vector encoding of the text description, sequence of vector encodings of text descriptions of each frame of video clip, vector representation of diffusion time step, noisy vector representation of the sequence of key points of video clip, and learned quarries.

3. The method of claim 1, wherein the diffusion motion model is trained with training data, wherein the training data comprises:
vector representations of text descriptions from a training set, and
vector representations of sequences of key points from the training set.

4. The method of claim 1, wherein the diffusion motion model is trained to detect, as the key points for each frame of the video clip to be generated, the key points that define a pose of an object in each frame of the video clip to be generated.

5. The method of claim 4, wherein the key points defining the pose of the object comprise at least one of one or more key points of the object's head, one or more key points of the object's body, one or more key points of the object's each upper limb, or one or more key points of the object's each lower limb.

6. The method of claim 5, wherein the key points of the object's head comprise key points of the object's face that define the object's emotion.

7. The method of claim 1, wherein the diffusion motion model comprises a forward process and a reverse process, and the diffusion motion model is performed iteratively until at least one of a loss function convergence feature is reached, or a predetermined number of epochs of training the diffusion motion model is completed.

8. The method of claim 7, wherein, during the forward process, T diffusion time steps are sequentially performed, at each of which Gaussian noise is added to the vector representation of the sequence of key points, to obtain noisy vector representations of the sequence of key points of the video clip in the T diffusion time steps.

9. The method of claim 8, wherein, during the reverse process, the diffusion motion model is trained by performing:
randomly sampling a time step t from [1, T−1],
predicting, by the diffusion motion model being trained, noise to be removed from the noisy vector representations of the sequence of key points of the video clip corresponding to the time step t in order to obtain a vector representation of the sequence of key points of the video clip corresponding to time step t−1,
calculating a loss function value between the predicted noise and an actual noise that was added to the vector representation of the sequence of key points of the video clip during the forward process at the time step t−1, and
performing backpropagation by calculating, based on the calculated loss function value, a gradient and updating weights of the diffusion motion model being trained based on the calculated gradient.

10. The method of claim 1, wherein the diffusion motion model is based on a transformer architecture with a self-attention mechanism.

11. The method of claim 3, wherein generating of the training set comprises:
detecting for each frame of each video clip of a plurality of video clips, a predetermined number of key points presented in each corresponding frame;
removing from a sequence of frames of each video clip, wherein the frames that not all the predetermined number of key points are detected, and
selecting, from the sequence of frames of each video clip, a predetermined number of equidistant-from-each-other frames representing a video clip to be included in the training set.

12. The method of claim 1, wherein mapping the vector representation of the sequence of key points comprises:
creating a series of empty images,
extracting, for each image of the series of empty images, pixel coordinates of key points of each image from the vector representation of the sequence of key points, and
filling, in each image of the series of empty images, the key points of each image as specified by the pixel coordinates.

13. An electronic device configured to generate a video clip from a text description, comprising: one or more processors; and
memory for storing instructions that, when executed by the one or more processors individually or collectively, cause the electronic device to:
receive the text description of the video clip to be generated,
obtain, based on the received text description, a vector representation of the text description,
obtain a vector representation of a sequence of key points of the video clip to be generated, by a diffusion motion model based on the obtained vector representation of the text description,
map the vector representation of the sequence of key points to a series of key point images of the video clip being generated, wherein each key point image from the series corresponding to a respective frame of the video clip being generated, and
generate a frame sequence of the video clip.

14. The electronic device of claim 13, wherein input data corresponding to the diffusion motion model comprises: vector encoding of the text description, sequence of vector encodings of text descriptions of each frame of video clip, vector representation of diffusion time step, noisy vector representation of the sequence of key points of video clip, and learned quarries.

15. The electronic device of claim 13, wherein the diffusion motion model is trained with training data, wherein the training data comprises:
vector representations of text descriptions from a training set, and
vector representations of sequences of key points from the training set.

16. The electronic device of claim 13, wherein the diffusion motion model is trained to detect, as the key points for each frame of the video clip to be generated, the key points that define a pose of an object in each frame of the video clip to be generated.

17. The electronic device of claim 16, wherein the key points defining the pose of the object comprise at least one of one or more key points of the object's head, one or more key points of the object's body, one or more key points of the object's each upper limb, or one or more key points of the object's each lower limb.

18. The electronic device of claim 17, wherein the key points of the object's head comprise key points of the object's face that define the object's emotion.

19. The electronic device of claim 13, wherein the diffusion motion model comprises a forward process and a reverse process, and the diffusion motion model is performed iteratively until at least one of a loss function convergence feature is reached, or a predetermined number of epochs of training the diffusion motion model is completed.

20. A non-transitory computer-readable storage medium, storing computer-executable instructions which, when executed by at least one processor, cause the at least one processor to at least:
receive the text description of the video clip to be generated,
obtain, based on the received text description, a vector representation of the text description,
obtain a vector representation of a sequence of key points of the video clip to be generated, by a diffusion motion model based on the obtained vector representation of the text description,
map the vector representation of the sequence of key points to a series of key point images of the video clip being generated, wherein each key point image from the series corresponding to a respective frame of the video clip being generated, and
generate a frame sequence of the video clip.
